(19) United States
(12) Patent Application Publication
(10) Pub. No.: US 2007/0023602 A1
(43) Pub. Date: Feb. 1, 2007

(54) Elevating transporter

(75) Inventor: Harold Fowler, Clearwater, FL (US)

Correspondence Address: LOUIS J FRANCO;LAW OFFICE OF LOUIS J FRANCO, 250 ARBOR, LUNENBURG, MA, 01462, US

(73) Assignee: Lockheed Martin Corporation

(21) Appl. No.: 11/194,775

(22) Filed: Aug. 1, 2005

(51) Int. Cl. E04G 25/00; A47F 5/00; F16M 13/00

(52) U.S. Cl. 248/351

(57) ABSTRACT

An elevating transporter for lifting and transporting an object includes a base from which depends a plurality of casters for engaging a surface over which the base is rollable. An elongated post supported by the base has upper and lower ends and is externally threaded along at least a portion of its length. An internally threaded collar rotatably carried by the base includes a set of internal threads configured for threadable engagement with, and support of, the external threads of the post such that, when the post does not rotate with respect to the base, and the collar is rotated about a rotation axis with respect to the base, the post is vertically displaced toward one of an uppermost and lowermost elevation. Attached to the post is a load-bearing platform including an upwardly facing load-bearing surface for supporting an object to be elevated and transported.

### BACKGROUND

1. Field

Although not so limited in its utility or scope, implementations of the present invention are particularly well suited for lifting and transporting modules of machinery or conveyor sections to different locations within a warehouse, machine shop or material handling facility, for example.

2. Brief Description of Illustrative Environments and Related Art

In various warehouse, machining, manufacturing and material-handling facilities, it is sometimes necessary to lift, relocate, position and level large, cumbersome modules of machinery, equipment and conveyor sections, for example. Personnel employed in such facilities have resorted to a variety of improvised methods and apparatus to assist in elevating and transporting modules within a facility. For example, a module is sometimes elevated using one or more floor jacks and then lowered onto one or more dollies for transport. With the module near the desired location, the module is again jacked up off the dollies and lowered to the floor where it may then be slid into place in accordance with a process sometimes requiring several persons. In addition to requiring skidding the module for some distance across the floor, the aforementioned illustrative method does not facilitate adjustment of the module to a desired height by, for example, the extension of one or module legs or “blocking up” under the module feet. An improvised method such as that described above is costly, due to the time and personnel often required, and poses a risk of injury to persons involved in its execution.

Alternative methods of moving equipment modules involve the use of a hand-operated hydraulic “pallet jack.” While pallet jacks are generally capable of supporting heavy loads, they are expensive, somewhat difficult to maneuver, particularly in tight spaces with small clearances, and require a substantial amount of floor and storage space. Pallet jacks are typically difficult to maneuver in tight spaces because they generally include a wheel under each of two forks and a pair of wheels under a lever and handle assembly, as is known to those involved in material-handling operations. While the wheels under the lever and handle assembly can typically be swiveled by movement of the handle to one side, the wheels supporting the forks are generally restricted to rotation about a non-swivelable rotation axis.

Accordingly, there exists a need for a compact elevating transporter with a load-bearing platform supported by a post that is infinitely positionable between uppermost and lowermost elevations with respect to a base that is freely rollable along two-dimensions in a horizontal plane.

### SUMMARY

An illustrative elevating transporter for lifting and transporting an object includes a base from which depends a plurality of casters for rollably supporting the base over a surface such as a shop, warehouse or garage floor or a parking lot or roadway, for example. In alternative versions, each caster includes a roller in the form of a wheel or ball with an endless annular tread for engaging the surface over which the base is to be rolled. Moreover, the roller is swivelable about a swivel axis that extends perpendicularly to the rotation axis about which the roller rotates when rolled. Because the casters support the base and enable rolling of the base over surfaces, the plurality of casters includes casters sufficient in number such that portions (i.e., the surface-engaging portions) of at least some of the treads define a support plane. In a typical embodiment, therefore, the plurality of casters will include at least three casters, although embodiments with as few as two casters are conceived as within the scope of the invention as defined in the appended claims. A two-caster embodiment is possible, for instance, when rollers having treads sufficiently wide to ensure stability are used.

An elongated post extending along a normal axis is supported by the base and includes longitudinally opposed upper and lower ends. The normal axis is oriented perpendicularly to the support plane; however, it is to be understood that, while the normal axis is defined so as to extend perpendicularly to the support plane and the post extends along the normal axis, the post is not necessarily parallel or “co-axial” with the normal axis and, therefore, the post is not necessarily itself perpendicular to the support plane. The post is externally threaded along at least a portion of its length and is reciprocably displaceable along the normal axis, and with respect to the base, between uppermost and lowermost elevations by virtue of its mechanical cooperation with a threaded collar. More specifically, an internally-threaded collar carried by the base includes a set of internal threads configured for threadable engagement with the external threads of the externally threaded post. The internally-threaded collar is carried by the base for rotation about a rotation axis such that, for example, when the post does not rotate with respect to the base, and the collar is rotated with respect to the base about the rotation axis, the post is displaced along the normal axis. More specially, when the collar is rotated in a first rotation direction, the post is axially displaced along the rotation axis toward its uppermost elevation. Conversely, when the collar is rotated in a second rotation direction opposite the first rotation direction, the post is axially displaced along the rotation axis toward its lowermost elevation.

In order to facilitate application of torque to the collar for rotation, various embodiments include a threaded collar having a keyed exterior surface configured for fitting engagement with the jaws of a leveraging tool (e.g. a wrench of fixed or adjustable jaw separation) to which is applied a force for rotation of the collar. Representative “keyed” configurations include square and hexagonal, in which case the collar may be essentially in the form of a nut. In alternative versions, at least one lever arm depends from the collar and exhibits at least a radial component of extension that is orthogonal to the rotation axis such that a properly directed force of sufficient magnitude applied thereto causes rotation of the collar with respect to the base. In at least one variation, the at least one lever arm comprises at least two lever arms that support an annular grip structure such that the at least two lever arms and the annular grip structure define a hand wheel of which the collar serves as the hub.

Various versions of an elevating transporter further comprise a load-bearing platform attached to the post. The load-bearing platform includes an upwardly-facing load-bearing surface for supporting an object to be elevated and transported. The load-bearing platform of some embodiments further includes upwardly-protruding, spaced apart fences wherein (i) each fence includes an inside surface and (ii) the load-bearing surface and the inside surfaces of the fences define, in combination, an object-supporting channel. The object-supporting channel is configured to engage, for example, a horizontally-extending frame member of an item of machinery or other structure to be lifted and moved along a floor. One function of the fences is to prevent that portion of a frame engaged by the load-bearing surface from slipping off the load-bearing surface. The fences also facilitate avoidance of undesired relative rotation of the post and base so that the post and platform can be elevated by rotation of the internally-threaded collar. In some versions, at least one fence is selectively movable toward and away from the other fence such that the width of the object-supporting channel defined between the fences is adjustable. In still additional versions, one fence is infinitely positionable with respect to the other between extreme proximate and separated positions. In accordance with one configuration, one fence can be forcibly urged toward the other by at least one threaded rod. In the latter configuration, the fences are forcibly urged toward one another in a manner analogous to the manner in which the movable jaw of a table vise is threadably urged toward a stationary jaw of the vise, although, again, in various versions, both fences may be movable. It will be appreciated that, in versions in which at least one fence is threadably movably toward an opposite fence, at least a portion of an object to be elevated and transporter can be clamped between the fences in order to secure the object to the load-bearing platform.

As alluded to above, and throughout the specification generally, the description of the movement or extension of an element as being “along” a referenced plane or axis, for example, does not necessarily mean that such movement or extension is along a plane or axis that is parallel to the referenced plane or axis or coplanar or co-axial therewith. By way of non-limiting illustration, a line oriented at an angle of 40 degrees in an x-y Cartesian grid may be said to “extend along” the x-axis because the magnitude of the x-component of any point along that line is greater than the corresponding y-component. Moreover, the description of a line or axis, for example, as “vertically extending” is to be read as “extending along a vertical axis.” Accordingly, a vertically extending axis is not necessarily truly vertical; instead such an axis extends along, but not necessarily parallel to, an axis that is truly vertical. It is in this spirit that like terminology is to be construed for purposes of this specification and the appended claims.

Representative, non-limiting embodiments are more completely described and depicted in the following detailed description and the accompanying drawings.

### BRIEF DESCRIPTION OF THE DRAWINGS

FIG. 1 shows an illustrative elevating transporter having a vertically extending externally-threaded post threadably supported by an internally threaded collar from which depend two lever arms for rotation of the collar and, thereby, vertical displacement of the post;

FIG. 2. shows an elevating transporter like that of FIG. 1 wherein two lever arms depending from an internally-threaded collar support an annular grip structure such that the lever arms and grip structure define a hand wheel which, when rotated, vertically displaces the post;

FIG. 3 depicts a version of an elevating transporter generally like the versions of FIGS. 1 and 2 wherein the internally-threaded collar exhibits a keyed exterior surface that facilitates engagement for rotation of the collar of the jaws of a leveraging tool such as fixed-size of adjustable wrench;

FIG. 4 depicts an illustrative elevating transporter having a load-bearing platform with two fixedly positioned, upwardly-extending fences between which is defined an object-supporting channel;

FIG. 5 shows and illustrative elevating transporter including a load-bearing platform from which fixedly depend a first fence with an inside surface and a stanchion positioned relative to the fence such that at least a portion of a load-bearing surface of the load-bearing platform extends between the stanchion and the fence and such that an externally threaded rod threadably supported by the stanchion and including a force-distributing pad rotatably attached in an inside end of the rod can by selective threaded away from and toward the fence for selective clamping of an object between the force-distributing pad and the inside surface of the fence; and

FIG. 6 shows a version of an elevating transporter wherein extending above a load-bearing surface are first and second threaded-rod-supporting stanchions relatively positioned such that at least a portion of the load-bearing surface extends between the them and such that an object can be selectively clamped between force-distributing pads rotatably attached to the inside ends of the rods.

### DETAILED DESCRIPTION

The following description of various embodiments of an elevating transporter is illustrative in nature and is therefore not intended to limit the scope of the invention or its application of uses.

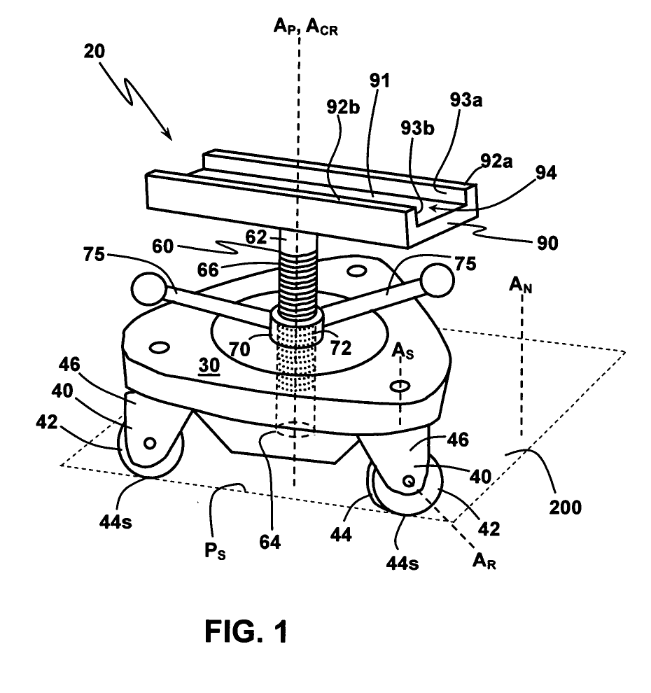

Referring to FIG. 1, an illustrative elevating transporter 20 includes a base 30. Depending downwardly from the base 30 is a plurality of casters 40 that rollably supports the base 30 over a surface 200. Each caster 40 includes a roller 42 with an endless annular tread 44 for engaging the surface 200 over which the base 30 is to be rolled. Moreover, each roller 42 is mounted for rotation about a rotation axis A_{R} in a yoke 46 that is pivotably mounted to the base 30 such that the yoke 46 and roller 42 are swivelable about a swivel axis A_{S} that extends perpendicularly to the rotation axis A_{R}. The surface-engaging portions 44s of the treads 44 define a support plane P_{S} that coincides with the surface 200 when surface 200 is planar as opposed, for example, to being convex, concave or uneven. A normal axis A_{N} extends orthogonally to the support plane P_{S} defined by the surface-engaging portions 44s of the treads 44.

Referring still to FIG. 1, the base 30 supports a post 60 that includes longitudinally opposed upper and lower ends 62 and 64 and a post axis A_{P} that extends along, but not necessarily parallel to or co-axially with, the normal axis A_{N} that is oriented perpendicularly to the support plane P_{S}. The post 60 includes a set of external threads 66 that extends along at least a portion of the length of the post 60. An internally-threaded collar 70 carried by the base includes a set of internal threads 72 configured for threadable engagement with the external threads 66 of the post 60. The internally-threaded collar 70 is carried by the base 30 for rotation about a collar rotation axis A_{CR} such that, when the post 60 does not rotate with respect to the base 30, and the collar 70 is rotated with respect to the base 30 about the collar rotation axis A_{CR}, the post 60 is displaced along the normal axis A_{N}. More specifically, when the collar 70 is rotated in a first rotation direction, the post 60 is axially displaced along the normal axis A_{N}, and the collar rotation axis A_{CR}, toward its uppermost elevation. Conversely, when the collar 70 is rotated in a second rotation direction opposite the first rotation direction, the post 60 is axially displaced along the normal axis A_{N} toward its lowermost elevation.

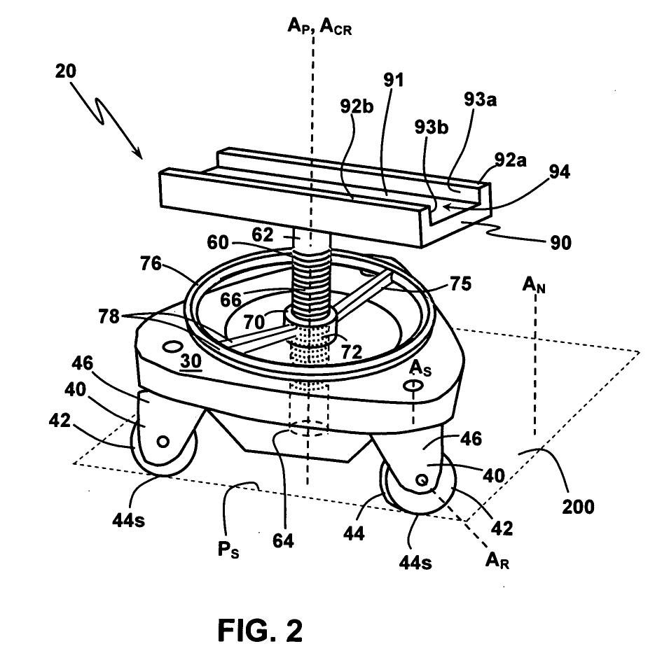

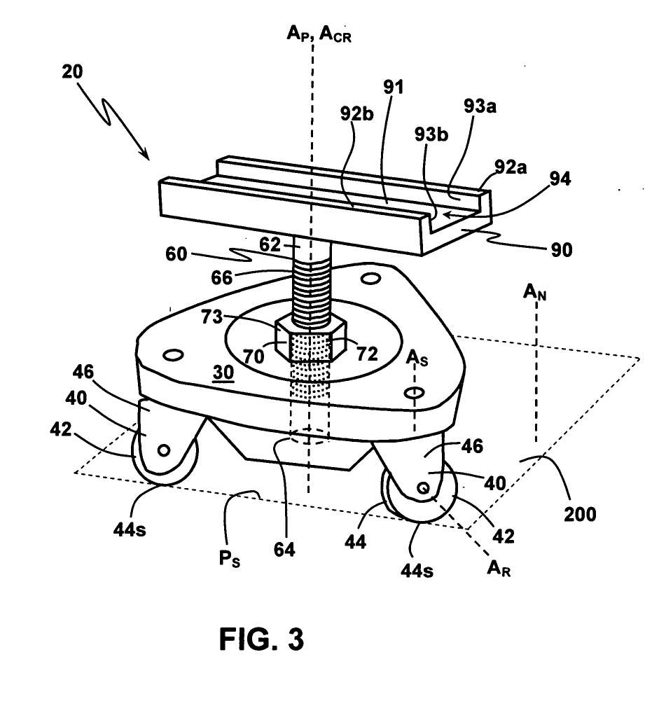

In order to facilitate rotation of the collar 70 without a tool such as a wrench, the collar 70 in the version depicted in FIG. 1 includes two oppositely-directed lever arms 75. Although angled upwardly to some degree so as to exhibit a component of extension along the collar rotation axis A_{CR}, each of the lever arms 75 exhibits a radial component of extension that is orthogonal to the collar rotation axis A_{CR} such that a properly directed force of sufficient magnitude applied thereto causes rotation of the collar 70 with respect to the base 30 in a manner readily comprehensible by those with even a rudimentary mechanical knowledge. Shown in FIG. 2 is a version in which a plurality of lever arms 75 supports an annular grip structure 76 such that a hand wheel 78 is defined by the lever arms 75, the annular grip structure 76 and the collar 70, with the collar 70 serving as the hub of the hand wheel 78. In still another illustrative embodiment shown in FIG. 3, the collar 70 includes a hexagonally configured exterior surface 73 that can be engaged by a wrench (not shown) of complimentary dimensions for turning of the collar 70. It will be appreciated that alternatively “keyed” exterior surfaces 73 are within the scope and contemplation of the invention.

Each illustrative version of an elevating transporter depicted in the drawings includes a load-bearing platform 90 that is attached to the upper end 62 of the post 60. The load-bearing platform 90 includes an upwardly-facing load-bearing surface 91 for supporting an object to be elevated and transported. Each of various load-bearing platforms 90 depicted further includes at least one upwardly-protruding (i.e., protruding above the load-bearing surface 91) fence 92a having an inside surface 93a, with some depicted versions including first and second spaced apart fences 92a and 92b which include, respectively, first and second inside surfaces 93a and 93b. In versions of the latter type, the load-bearing surface 91 and the inside surfaces 93a and 93b of the fences 92a and 92b define, in combination, an object-supporting channel 94. One function of the fences 92a and 92b is to prevent that portion of an object (not shown) engaged by the load-bearing surface 91 from slipping off the load-bearing platform 90. The fences 92a and 92b also facilitate avoidance of undesired relative rotation of the post 60 and base 30 so that the post 60 and platform 90 can be elevated by rotation of the internally-threaded collar 70.

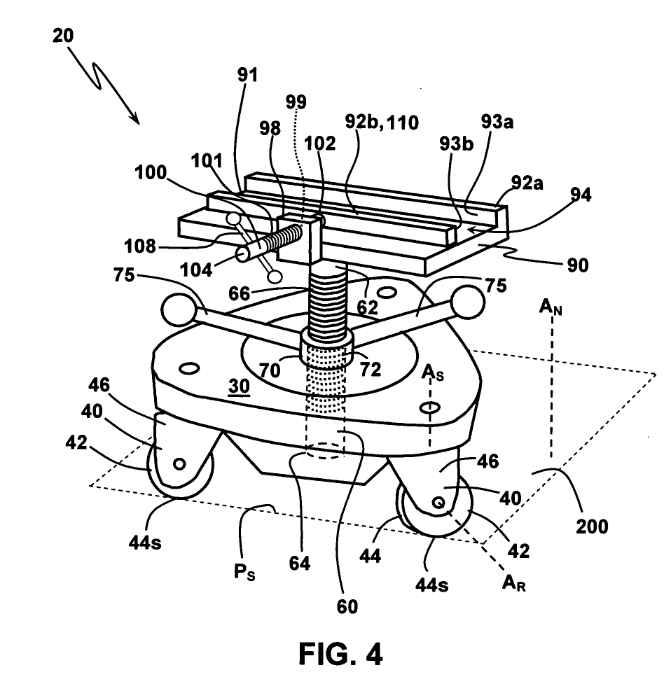

While FIGS. 1 through 3 depict embodiments in which first and second fences 92a and 92b are in fixed positions relative to one another and to the load-bearing surface 91, shown in FIG. 4 is a version in which the fences 92a and 92b are relatively movable such that the width of the object-supporting channel 94 defined between the fences 92a and 92b is adjustable. In the illustrative version of FIG. 4, the first fence 92a is fixed relative to the load-bearing surface 91 and the second fence 92b is threadably movable toward and away from the first fence 92a by the selective rotation of a threaded rod 100. The threaded rod 100 exhibits external threads 101 extending at least part of the way between first and second rod ends 102 and 104 and its supported by an upwardly-extending stanchion 98 having, situated above the load-bearing surface 91, internal threads 99 through which the external threads 101 are threadably received. The stanchion 98 is in fixed positional relationship with the first fence 92a and the load-bearing surface 91 and the second fence 92b is situated between the stanchion 98 and the first fence 92a. The first rod end 102 is rotatably joined with the second fence 92b to the inside of the stanchion 98 (i.e., between the stanchion 98 and the first fence 92a), while the second rod end 104 is situated to the outside of the stanchion 98 where it is accessible to a user for rotation and, thereby, axial displacement of the threaded rod 100 and the second fence 92b. In the version of FIG. 4, the threaded rod 100 also includes, to the outside of the stanchion 98, a slidably-retained lever 108 extending orthogonally to the threaded rod 100 in order to facilitate rotation of the threaded rod 100. It will be appreciated that the illustrative, non-limiting configuration of FIG. 4 renders the first and second fences 92a and 92b infinitely positionable with respect to one another between extreme proximate and separated positions. Moreover, the second fence 92b can be threadably urged toward the first fence 92a like the movable jaw of a table vise can be threadably urged toward the immovable stationary vise jaw; this enables a portion of an object (e.g., a frame member of an item of machinery) to be clamped between the fences 92a and 92b such that that portion of the object is rendered immobile with respect to the load-bearing platform 90.

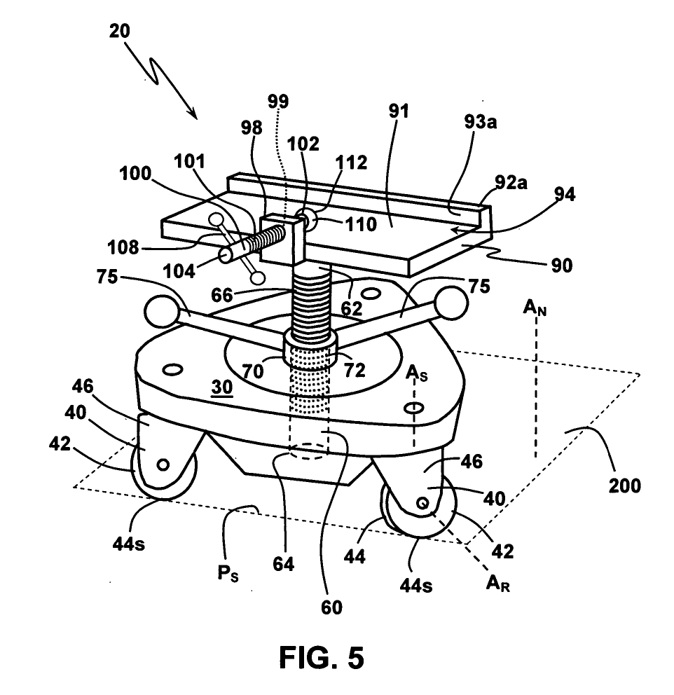

Shown in FIG. 5 is an alternative version in which the load-bearing platform 90 includes an upwardly-protruding first fence 92a with a first inside surface 93a. An upwardly-extending stanchion 98 is fixedly positioned relative to the load-bearing surface 91 and is situated with respect to the first fence 92a such that at least a portion of the load-bearing surface 91 extends between the stanchion 98 and the first inside surface 93a. The stanchion 98 includes internal threads 99 threadably supporting the external threads 101 of a threaded rod 100 having first and second ends 102 and 104 situated, respectively, to the inside of the stanchion 98 (i.e., between the stanchion 98 and the first inside surface 93a) and the outside of the stanchion 98. Instead of a second fence 92b, as in the version described in conjunction with FIG. 4, the first end 102 of the rod 100 has rotatably attached thereto a circular force-distributing pad 110 with a circular force-exerting surface 112, much like the “circular-footprint” force-distributing pad rotatably attached to the inside end of the threaded rod included on a common C-clamp. While the illustrative embodiment of FIG. 5 includes only a single stanchion 98 and threaded rod 100, it will be appreciated that various alternative configurations are within the scope and contemplation of the invention as expressed in the appended claims including, by way of non-limiting example, (i) a version with plural (i.e., at least two) stanchions 98, each of which stanchions 98 supports a single threaded rod 100 and (ii) a version with a single, horizontally elongated stanchion 98 supporting plural threaded rods 98. It will be appreciated that with any of these versions, a portion of the object to be elevated and transported can be selectively clamped between the first inside surface 93a of the first fence 92a and at least one force-distributing pad 110 by the selective rotation of the threaded rod 98 for axial movement toward the first fence 92a with the portion of the object situated between the first fence 92a and the at least one force-distributing pad 110. It will also be appreciated that in the version discussed in conjunction with FIG. 4, for example, the horizontally-elongated movable second fence 92b is a special case of, more generally, a force-distributing pad 110 and that the second inside surface 93b is a horizontally-elongated force-exerting surface.

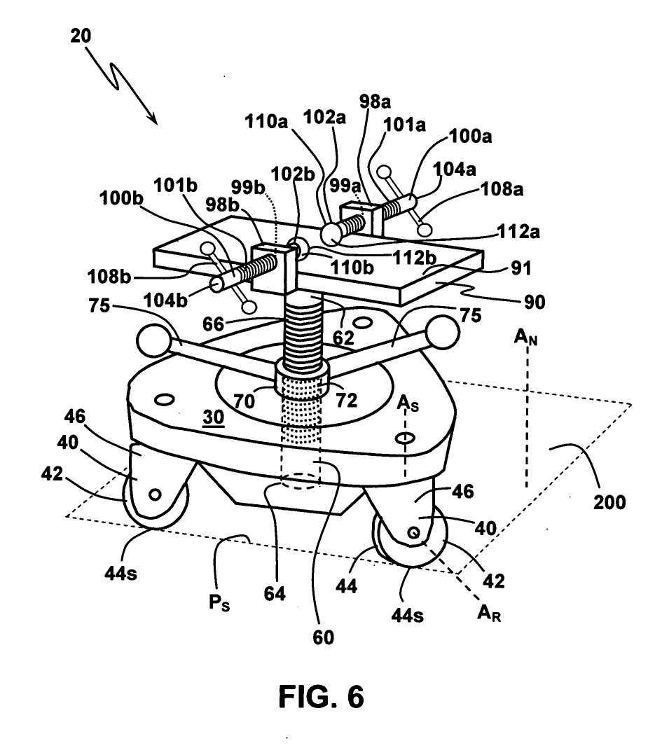

In the version of FIG. 6, upwardly-extending first and second stanchions 98a and 98b are relatively situated such that at least a portion of the load-bearing surface 91 extends between them. The first stanchion 98a is fixedly positioned relative to the load-bearing surface 91 and has, situated above the load-bearing surface 91, internal threads 99a through which the external threads 101a of a first externally-threaded rod 100a are threadably received and supported. The first externally-threaded rod 100a includes a first end 102a situated to the inside of the first stanchion 98a and a second end 104a situated to the outside of the first stanchion 98a. The first end 102a of the first externally-threaded rod 100a, furthermore, has rotatably attached thereto a first force-distributing pad 110a with a first force-exerting surface 112a generally facing that portion of the load-bearing platform 90 above which the second stanchion 98b extends. Analogously to the first stanchion 98a, the second stanchion 98b is fixedly positioned relative to the load-bearing surface 91 and has, situated above the load-bearing surface 91, internal threads 99b through which the external threads 101b of a second externally-threaded rod 100b are threadably received and supported. The second externally-threaded rod 100b includes a first end 102b situated to the inside of the second stanchion 98b and a second end 104b situated to the outside of the second stanchion 98b. The first end 102b of the second externally-threaded rod 100b, furthermore, has rotatably attached thereto a second force-distributing pad 110b with a second force-exerting surface 112b generally facing that portion of the load-bearing platform 90 above which the first stanchion 98a extends. The first and second stanchions 98a and 98b are relatively situated such that (i) at least a portion of the load-bearing surface 91 extends between the stanchions 98a and 98b and (ii) a portion of an object (not shown) to be elevated and transported can be selectively clamped between the first and second force-exerting surfaces 112a and 112b by the selective rotation of at least one of the first and second externally-threaded rods 100a and 100b. Although in the version of FIG. 6, the force-distributing pads 110a and 110b include, respectively, a circular first force-exerting surface 112a and a circular second force-exerting surface 112b, either or both of the force-distributing pads 110a and 110b could be, instead, in the form of a horizontally-elongated fence 92a/b with a horizontally-elongated inside surface 93a/b as previously indicated.

The foregoing is considered to be illustrative of the principles of the invention. Furthermore, since modifications and changes to various aspects and implementations will occur to those skilled in the art without departing from the scope and spirit of the invention, it is to be understood that the foregoing does not limit the invention as expressed in the appended claims to the exact constructions, implementations and versions shown and described.

What is claimed is:

1. An elevating transporter for lifting and transporting an object, the elevating transporter comprising:
a base from which depends a plurality of casters for engaging a surface over which the base is rollable, each caster including an endless annular tread for engaging the surface, the casters being sufficient in number such that surface-engaging portions of at least some of the treads define a support plane;
an elongated post supported by the base and having upper and lower ends and a post axis extending along a normal axis that is oriented perpendicularly to the support plane, the post being externally threaded along at least a portion of its length and reciprocably displaceable with respect to the base between uppermost and lowermost elevations;
an internally threaded collar rotatably carried by the base and including a set of internal threads configured for threadable engagement with the external threads of the externally threaded post such that, when the post does not rotate with respect to the base and the collar is rotated about a rotation axis with respect to the base, the post is displaced along the normal axis toward one of (i) the uppermost elevation and (ii) the lowermost elevation; and
a load-bearing platform attached to the post and including an upwardly facing load-bearing surface for supporting an object to be elevated and transported.

2. The elevating transporter of claim 1 further comprising at least one lever arm depending from the collar and exhibiting at least a radial component of extension that is orthogonal to the rotation axis such that a force of sufficient magnitude applied thereto causes rotation of the collar with respect the base.

3. The elevating transporter of claim 2 wherein the at least one lever arm comprises at least two lever arms and wherein the at least two lever arms support an annular grip structure such that the at least two lever arms and the annular grip structure define a hand wheel.

4. The elevating transporter of claim 1 wherein the internally threaded collar includes a keyed exterior surface configured for selective fitting engagement by jaws of a leveraging tool to which tool can be applied a force for rotation of the collar.

5. The elevating transporter of claim 1 wherein (i) the load-bearing platform includes upwardly protruding, spaced apart first and second fences, (ii) each fence includes an inside surface and (iii) the inside surfaces of the fences face one another and define, in combination with the load-bearing surface, an object-supporting channel.

6. The elevating transporter of claim 5 wherein one fence is selectively movable toward and away from the other fence such that the width of the objecting-supporting channel defined between the fences is adjustable.

7. The elevating transporter of claim 6 wherein at least one of the first and second fences is rotatably attached to a first end of an externally-threaded rod that is supported by a stanchion fixedly positioned relative to the load-bearing surface and having internal threads through which threads of the externally-threaded rod are threadably received and wherein each of the at least one of the first and second fences that is rotatably attached to the first end of a threaded rod is situated between the stanchion supporting the externally-threaded rod to which that fence is rotatably attached and the other of the first and second fences such that the fence (i) is threadably movable toward and away from the other fence by the selective rotation of the threaded rod and (ii) can be threadably urged toward the other fence in order to clamp between the inside surfaces of the first and second fences at least a portion of an object to be elevated and transported.

8. The elevating transporter of claim 7 wherein the position of one of the first and second fences is fixed relative to the load-bearing surface and the other of the first and second fences is threadably movable toward and away from the fence that is fixed relative to the load-bearing platform by the selective rotation of the threaded rod to which the threadably movable fence is rotatably attached.

9. The elevating transporter of claim 7 wherein each of the first and second fences is rotatably attached to the first end of a threaded rod supported by a stanchion for selective threadable movement toward and away from the other of the first and second fences.

10. An elevating transporter for lifting and transporting an object, the elevating transporter comprising:
a base from which depends a plurality of at least three casters for engaging a surface over which the base is rollable, each caster including an endless annular tread for engaging the surface, the surface-engaging portions of at least some of the treads defining a support plane tangent to the surface-engaging portions defining the support plane;
an elongated post supported by the base and having upper and lower ends and a post axis extending along a normal axis that is oriented perpendicularly to the support plane, the post being externally threaded along at least a portion of its length and reciprocably displaceable with respect to the base between uppermost and lowermost elevations;
an internally threaded collar rotatably carried by the base and including a set of internal threads configured for threadable engagement with the external threads of the externally threaded post such that, when the post does not rotate with respect to the base and the collar is rotated about a rotation axis with respect to the base, the post is displaced along the normal axis toward one of (i) the uppermost elevation and (ii) the lowermost elevation;
at least two lever arms depending from the collar, each lever arm exhibiting at least a radial component of extension that is orthogonal to the rotation axis such that a force of sufficient magnitude applied thereto causes rotation of the collar with respect the base; and
a load-bearing platform attached to the post and including first and second sides and an upwardly facing load-bearing surface extending between the first and second sides for supporting an object to be elevated and transported.

11. The elevating transporter of claim 10 wherein the at least two lever arms support an annular grip structure such that the at least two lever arms and the annular grip structure define a hand wheel.

12. The elevating transporter of claim 10 wherein (i) the load-bearing platform includes upwardly protruding, spaced apart first and second fences, (ii) each fence includes an inside surface and (iii) the inside surfaces of the fences face one another and define, in combination with the load-bearing surface, an object-supporting channel.

13. The elevating transporter of claim 12 wherein at least one of the first and second fences is rotatably attached to a first end of an externally-threaded rod that is supported by a stanchion fixedly positioned relative to the load-bearing surface and having internal threads through which threads of the externally-threaded rod are threadably received and wherein each of the at least one of the first and second fences that is rotatably attached to the first end of a threaded rod is situated between the stanchion supporting the externally-threaded rod to which that fence is rotatably attached and the other of the first and second fences such that the fence (i) is threadably movable toward and away from the other fence by the selective rotation of the threaded rod and (ii) can be threadably urged toward the other fence in order to clamp between the inside surfaces of the first and second fences at least a portion of an object to be elevated and transported.

14. The elevating transporter of claim 10 wherein the load-bearing platform further comprises:
an upwardly-protruding first fence including a first inside surface;
an upwardly extending stanchion fixedly positioned relative to the load-bearing surface and having, situated above the load-bearing surface, internal threads through which the external threads of an externally-threaded rod are threadably received, the externally-threaded rod further including a first end situated to the inside of the stanchion, between the stanchion and the first inside surface, and a second end situated to the outside of the stanchion, the stanchion being situated with respect to the fence such that at least a portion of the load-bearing surface extends between the stanchion and the first inside surface and such that the first end of the threaded rod is threadably movable toward and away from the first inside surface by the selective rotation of the threaded rod; and
a force-distributing pad rotatably attached to the first end of the threaded rod, wherein the force-distributing pad includes a force-exerting surface that faces the first inside surface and can be threadably urged toward the first inside surface in order to clamp between the force-exerting surface and the first inside surface at least a portion of an object to be elevated and transported.

15. The elevating transporter of claim 14 wherein the first fence is fixedly positioned relative to the load-bearing surface and the force-distributing pad one of (i) includes a circular force-exerting surface and (ii) is a horizontally-elongated second fence having a second inside surface facing the first inside surface and being selectively movable toward and away from the first inside surface by the selective rotation of the externally threaded rod.

16. The elevating transporter of claim 10 wherein the load-bearing platform further comprises:
an upwardly extending first stanchion fixedly positioned relative to the load-bearing surface more proximate the first side than the second side of the load-bearing platform and having, situated above the load-bearing surface, internal threads through which the external threads of a first externally-threaded rod are threadably received, the first externally-threaded rod including a first end situated to the inside of the stanchion and a second end situated to the outside of the stanchion, the first end of the first externally-threaded rod having rotatably attached thereto a first force-distributing pad with a first force-exerting surface facing the second side of the load-bearing platform; and
an upwardly extending second stanchion fixedly positioned relative to the load-bearing surface more proximate the second side than the first side of the load-bearing platform and having, situated above the load-bearing surface, internal threads through which the external threads of a second externally-threaded rod are threadably received, the second externally-threaded rod including a first end situated to the inside of the stanchion and a second end situated to the outside of the stanchion, the first end of the second externally-threaded rod having rotatably attached thereto a second force-distributing pad with a second force-exerting surface facing the first side of the load-bearing platform, wherein
the first and second stanchions relatively situated such that (i) at least a portion of the load-bearing surface extends between the stanchions and (ii) a portion of an object to be elevated and transported can be selectively clamped between the first and second force-exerting surfaces by the selective rotation of at least one of the first and second threaded rods.

17. The elevating transporter of claim 16 wherein each of the first and second force-distributing pads one of (i) includes one of circular first force-exerting surface and a circular second force-exerting surface and (ii) is a horizontally-elongated fence having one of a first inside surface and a second inside surface that is a horizontally-elongated force-exerting surface.
